(19) United States
(12) Patent Application Publication
(10) Pub. No.: US 2026/0307228 A1
(43) Pub. Date: Oct. 8, 2026

(54) POWER TOOL AIR FLOW

(71) Applicant: BLACK & DECKER INC., New Britain, CT (US)

(72) Inventors: Benjamin SCHMIDT, Mainz (DE); Tobias HEEP, Hadamar (DE); Kevin BHIKADIYA, Frankfurt am Main (DE); Yasar AKBABA, New-Isenburg (DE)

(21) Appl. No.: 19/637,811

(22) Filed: Apr. 2, 2026

(30) Foreign Application Priority Data
Apr. 2, 2025 (EP) 25167948.6

(51) Int. Cl. B25D 16/00; B25D 17/20; B25D 17/24; B25D 17/04

(52) U.S. Cl. CPC B25D 16/00; B25D 17/20; B25D 17/24; B25D 17/04

(57) ABSTRACT

A power tool including: a drive housing including an air inlet and an air outlet, an assembly movably mounted within the drive housing, wherein the assembly includes a motor and an air flow passage, a fan configured to generate airflow from the air inlet to the air outlet, a divider configured to divide the drive housing into a first internal section including the air inlet and a second internal section including the air outlet, the first internal section and the second internal section fluidly linked by the air flow passage. The divider substantially reduces or prevents airflow between the first and second internal sections except through the air flow passage in which the divider includes a labyrinth structure, at least part of which is coupled to the assembly.

### CROSS-REFERENCE TO RELATED APPLICATIONS

This application claims priority to EP Patent Application No. 25167948.6, filed on Apr. 2, 2025, which is incorporated herein by reference in its entirety.

### BACKGROUND OF THE INVENTION

### Field of the Invention

The present disclosure relates to a power tool. In particular, the present disclosure relates to the cooling of a power tool.

### Description of the Related Art

Construction tools for drilling or chiselling masonry or breaking concrete are known. One such tool is a hammer drill which comprises a reciprocating hammer operatively coupled to a motor; this hammering action may be used while drilling (i.e. while a drill bit is rotating) to form holes through hard materials, including masonry, or it may be used without rotation to act as a chisel. During operation, the motor may experience high load conditions and this may mean that the motor will get hot during operation. In order to ensure the motor performs under optimal conditions during operation the motor is cooled. However, existing systems may not be as efficient or as reliable as they could be.

Construction tools having a hammering action also produce significant vibration, which can lead to a poor user experience or may even harm the user. Reducing the vibration produced by these tools would be beneficial to the user.

### SUMMARY OF THE INVENTION

The invention provides a power tool that reduces the generated vibrations and additionally provides improved cooling for increased performance and tool life.

In a first aspect, the invention provides a power tool comprising: a drive housing comprising an air inlet and an air outlet, an assembly movably mounted within the drive housing, wherein the assembly comprises a motor and an air flow passage, a fan configured to generate airflow from the air inlet to the air outlet, and a divider configured to divide the drive housing into a first internal section comprising the air inlet and a second internal section comprising the air outlet, the first internal section and the second internal section fluidly linked by the air flow passage, wherein the divider substantially reduces or prevents airflow between the first and second internal sections except through the air flow passage, wherein the divider comprises a labyrinth structure, at least part of which is coupled to the assembly.

In a second aspect, the invention provides a power tool comprising: a drive housing comprising an air inlet and an air outlet, an assembly movably mounted within the drive housing, wherein the assembly comprises a motor and an air flow passage, a fan configured to generate airflow from the air inlet to the air outlet, a divider configured to divide the drive housing into a first internal section upstream of the motor and a second internal section downstream of the motor, wherein the first internal section comprises the air inlet and the second internal section comprises the air outlet, the first internal section and second internal section fluidly linked by the air flow passage, wherein the divider substantially reduces or prevents airflow between the first and second internal sections except through the air flow passage, and wherein at least part of the divider moves with the assembly.

The power tool may comprise a chuck configured to hold a bit, wherein the bit defines a first axis along its length and wherein the bit is configured to rotate about and/or translate along the first axis.

The assembly of the power tool may be movably mounted within the drive housing such that it can reciprocate parallel to the first axis defined by the bit configured to be held in the chuck.

The assembly may comprise the fan.

The assembly may comprise a gearbox located in the second internal section, and wherein the motor may comprise a motor shaft configured to drive the gearbox.

The motor may comprise a stator and a rotor, wherein an annular gap exists between the rotor and the stator, wherein the air flow passage is at least partially defined by the annular gap.

The divider may comprise a labyrinth structure. The labyrinth structure may comprise at least one first grooved section extending from a wall of the drive housing and at least one first baffle attached to the assembly, wherein the at least one first baffle is configured to move within a groove of the at least one first grooved section as the assembly moves relative to the drive housing.

The at least one first grooved section may comprise a front grooved section attached to a front wall of the drive housing and a rear grooved section attached to a rear wall of the drive housing, the front and rear wall being separated along the first axis, wherein the at least one first baffle comprises corresponding front and rear baffles attached to the assembly.

The at least one first grooved section may comprise a front grooved section attached to the front wall of the drive housing and a rear grooved section attached to the rear wall of the drive housing and side grooved sections attached to the respective side walls adjoining the front and rear walls, wherein at least one first baffle comprises corresponding front, rear and side baffles attached to the assembly.

The divider may comprise an apertured plate and a sealing extension attached to the assembly and configured to sealing engage around the aperture, wherein the aperture and sealing extension are sized such that the sealing extension remains sealing engaged around the aperture as the assembly moves.

The divider may comprise an elastic material connected to the assembly and to the walls of the drive housing.

The motor may comprise a motor housing, wherein the divider is attached to the motor housing.

The power tool may be a hammer drill, a rotary hammer, a demolition drill, or a reciprocating saw.

Where a labyrinth structure is discussed, it is meant that air has to deviate from its path at least once to pass through the structure, thus minimising the amount of air that passes through the structure. A labyrinth structure may cause the air to deviate from its path by ≥ 90 degrees, ≥ 135 degrees, or ≥ 180 degrees. A labyrinth structure may cause the air to deviate two or more times from its path in order to pass through the structure; for instance, the air may have to deviate 90 degrees, then 180 degrees, and then 90 degrees to pass through the structure. In a more complex labyrinth structure, the air may have to deviate 90 degrees, then 180 degrees, then a further 180 degrees, and then 90 degrees to pass through the labyrinth structure.

### BRIEF DESCRIPTION OF THE DRAWINGS

This disclosure provides the following figures to aid in understanding the invention:

FIG. 1 provides a schematic outline of several features of the power tool according to the invention.

FIG. 2 provides a schematic view of the several internal features of the power tool according to the invention.

FIG. 3 provides an illustration of desired airflow within the power tool.

FIG. 4 provides an illustration of undesirable airflow within the power tool.

FIG. 5 provides an illustration of the use of a divider for controlling airflow.

FIGS. 6A and 6B provide an illustration of a divider using grooved sections and baffles.

FIGS. 7A and 7B provide an illustration of a divider using an apertured plate and an annular sealing extension.

### DETAILED DESCRIPTION OF THE INVENTION

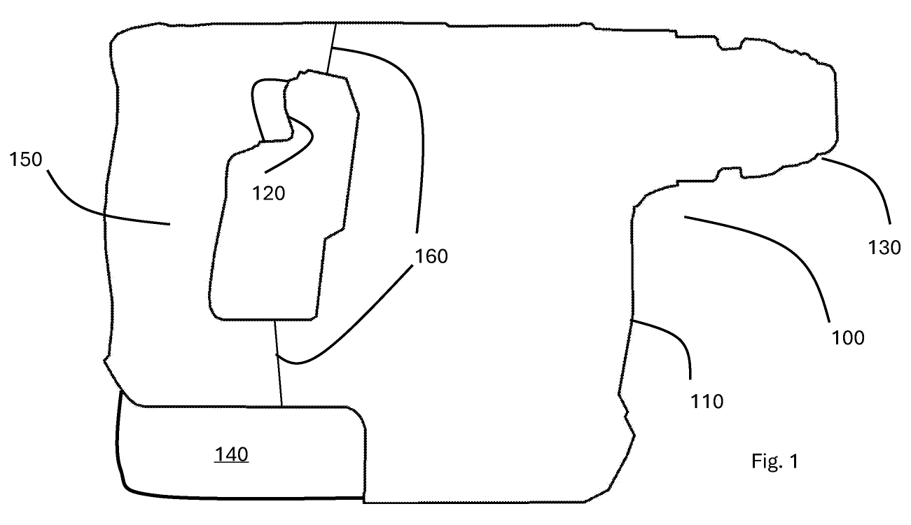

FIG. 1 shows a power tool 100 according to the invention. As shown, the power tool is a hammer drill, although the power tool could be a rotary hammer, a demolition drill, or a reciprocating saw, with the necessary modifications being known to the skilled person. The power tool 100 comprises a drive housing 110, a trigger 120, a chuck 130, a battery 140, and a grip housing 150. As shown, the drive housing 110 and grip housing 150 have continuous outer walls and would share a continuous internal volume; however, partitions 160 act to divide this internal volume so as to form an effectively separate drive housing 110 and grip housing 150. In the description of the following embodiment, when the walls of the drive housing are discussed, this is intended to include the faces of the partitions 160 which face the drive housing. The battery may be decoupled from the drive housing and/or grip housing by a dampening element (not shown) to minimise damage to the battery from vibrations.

The hammer drill is used to drill holes into masonry or other such materials using a drill bit (not shown); alternatively, or in addition, the hammer drill is used to chisel into masonry or other such materials using a chisel bit (not shown). The drill and/or chisel bits are retained in chuck 130, although the internal mechanisms of the chuck are not described or shown here. Both actions involve a percussive impact being imparted along the axis of the drill or chisel bit so as to impact the material. The main difference between drilling and chiselling is that the drill bit is designed to rotate at high speeds during use; in contrast, a chisel bit may not rotate, or may minimally rotate, so as to ensure a consistent chisel line.

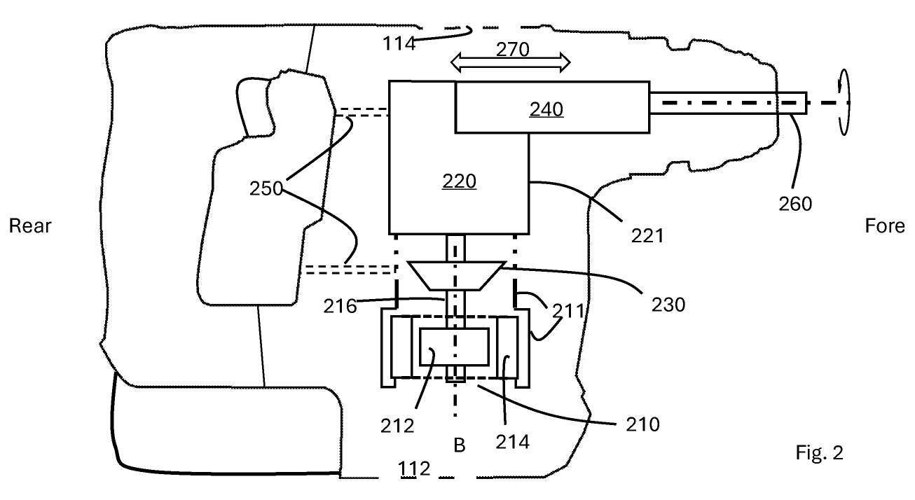

The internal mechanisms allowing for this percussive drilling and/or chiselling action are best shown in FIG. 2, which shows a schematic internal view of the power tool 100 of FIG. 1. As shown, the power tool 100 additionally comprises a motor 210 contained in a motor housing 211, a gearbox 220 contained in a gearbox housing 221, a fan 230, a hammer mechanism 240, a drill mechanism (not shown) and a controller (not shown). The percussive impacts discussed above are provided, at least in part, by the hammer mechanism which repeatedly impacts a bit (shown in schematic form as bit 260) held in the chuck so that the bit is sharply moved along its axis. The axis of the bit is shown as axis A. This allows the bit to impact or hammer the material and break it apart, thus allowing materials such as brick and concrete to be drilled through or chiselled. Many types of hammer mechanism are known to the skilled person and will not be discussed in detail here.

This hammering action produces significant vibration which can easily be transmitted through the drive housing and to the user, which leads to a poor user experience and potentially lasting physical damage. In the power tool 100 of FIG. 2, to reduce vibrations transmitted to the user when drilling, the motor housing 211 and gearbox housing 221 are configured to move or translate within the drive housing. In particular, the gearbox housing 221 is slidably mounted to a pair of steel pins (not shown) both parallel to axis A, wherein the steel pins are fixed to the drive housing. The skilled person would be aware of other ways in which the gearbox housing 221 can be slidingly mounted to the drive housing so that it can reciprocate parallel to axis A. The motor housing 211 is fixedly connected to the gearbox housing 221 by bolts (not shown) to form a floating assembly (or assembly), wherein both the motor housing 211 and gearbox housing 221 can reciprocate together within the drive housing. The hammer mechanism is shown schematically at FIG. 2; the skilled person is well aware of how such hammer mechanisms work and the detailed workings of the hammer mechanism will not be shown or discussed further. In this embodiment, chuck 130 also forms part of the floating assembly and therefore moves together with the motor housing 211, gearbox housing 221, and hammer mechanism; the movement of chuck 130 is not shown. This arrangement allows the floating assembly (or assembly) to reciprocate forwards and rearwards parallel to axis A, as shown schematically by the arrows 270 at FIG. 2, thus at least partly decoupling the floating assembly from the drive housing. As shown in FIG. 2, the rear end of the tool is defined as the grip end of the tool while the front or fore end of the tool is defined as the chuck end of the tool.

The vibration reduction is further enhanced through the use of compression springs 250, as shown in FIG. 2, arranged such that the axes of the respective springs are parallel to axis A. As the assembly moves rearwards, the compression springs help dampen this movement and thus reduce the vibrations transmitted to the user. The skilled person would be aware of other damping mechanisms such as rubber dampers or dashpots that could be used to dampen the vibration.

The hammer mechanism 240 and drilling mechanism (not shown) are both driven by the gearbox 220, which is in turn driven by the motor 210. A mode selector dial (not shown) is used to choose which mode the hammer drill is set to; for instance, if the hammer drill is set to “drill but not hammer”, the gearbox 220 will disengage the motor from the hammer mechanism but will remain engaged with the drilling mechanism. If the hammer drill is set to “hammer but not drill” (e.g. for chiselling) the gearbox 220 will disengage the drilling mechanism and may additionally lock the chisel bit at a given orientation. In a third “hammer and drill” mode, both the drilling mechanism and hammer mechanism are engaged. Such mode selectors and gearboxes are known in the art and will not be described further.

The motor is a brushless DC motor comprising an internal rotor 212 and a surrounding stator 214. The stator 214 is held within motor housing 211. As can be seen, the stator 214 is an annular cylinder which extends along a longitudinal axis B. Both the cylinder and the hole formed through the cylinder are co-linear with longitudinal axis B. The rotor is also cylindrical and extends along the same longitudinal axis B as the stator 214; a motor shaft 216 projects from both sides of the cylinder and is also co-linear with the longitudinal axis B. The external diameter of the rotor is slightly smaller than the internal diameter of the stator 214; because of this an annular gap exists between the rotor and the stator, the gap extending along the longitudinal axis. The motor shaft extends into the gearbox and engages with the internal mechanism of the gearbox to drive the drill and/or hammer mechanism depending on the mode selector setting.

The motor generates significant heat during use and may overheat during prolonged and/or intense use of the tool. The components of the gearbox can generate significant heat through the repetitive contact between, e.g., meshing gears, particularly under prolonged and/or intense use of the tool. An increased motor and/or gearbox temperature heat can lead to higher motor resistance and/or reduced gearbox efficiency; for cordless tools (i.e. battery powered), this can lead to the battery discharging more quickly for a given task, and thus reduced battery life. In both corded and cordless tools, increased temperatures can lead to increased wear and increased risk of malfunction.

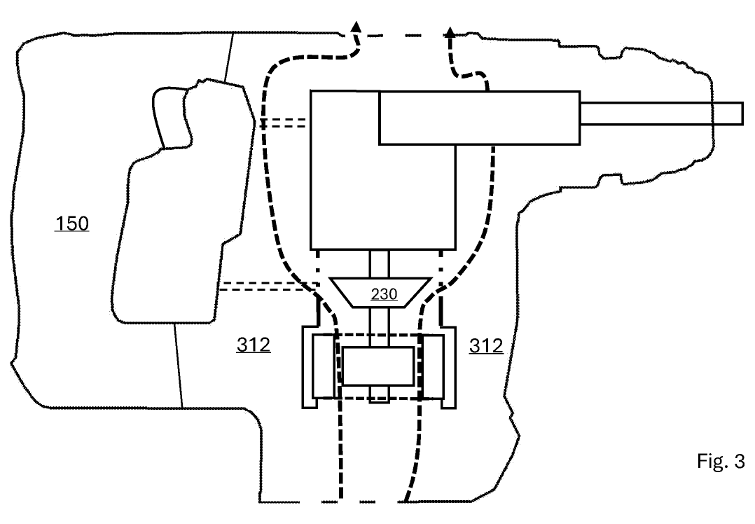

To minimise heat build-up within the motor and gearbox, a cooling system is provided. As shown in FIG. 3, the cooling system provides an air flow path through the motor housing 211 and around the gearbox housing 221. The airflow is generated by fan 230, which is directly connected to the motor shaft 216 and located between the motor 210 and the gearbox 220. The fan 230 is a radial fan which acts to pull air into the drive housing from an air inlet 112 formed in the wall of the drive housing and expel it from an air outlet 114 also formed in the wall of the drive housing. The air inlet and air outlets are formed by slots through the walls of the drive housing. As shown, the fan is located in a volume formed between the motor housing 211 and gearbox housing 221, which are bolted together. Cut-outs or openings are provided in the motor housing (as shown) and/or gearbox housing to allow fluid communication between the fan and downstream parts of the drive housing.

As shown, an air flow passage is formed through the annular gap of the motor so as to effectively cool both the rotor and the stator. The flow of air is represented by arrows. Only two arrows either side of the rotor are shown in the 2D cross-sectional view; however, it should be understood that air flow may occur through the entire volume of the annular gap. As discussed below, the air flow passage may comprise further channels through the rotor and/or stator.

Downstream of the motor, the air also flows past the gearbox in order to cool the gearbox. The gearbox housing is formed of metal therefore improving the conduction of heat from the gearbox internals to the cooling airflow. The gearbox, which is part of the floating assembly, is located within the walls of the drive housing. The air therefore flows through the space between the gearbox housing and the walls of the drive housing.

Therefore, as shown, the air flows from the air inlet, through the annular gap of the motor, around the gearbox housing, and out of the air outlet. This described route is not exhaustive and the air may flow through, around, or over other components as required or as necessitated by the particular design of a tool. As shown the air flows substantially perpendicularly to the reciprocal motion of the floating assembly (i.e. the air flows perpendicular to axis A). Having the air flowing substantially perpendicular to axis A may minimise blowing air onto the workpiece and/or sucking air from the workpiece. Sucking air from the workpiece may cause dust to enter the tool body and blowing air onto the work piece may circulate dust around the user, both of which are undesirable.

As can be seen, it is desirable to maximise air flow through the motor housing 211 and around the gearbox housing as the motor and gearbox generate substantial heat. This can be achieved by minimising the flow of air from the drive housing into, e.g., the grip housing 150. In this embodiment, air flowing into the drive housing is prevented from flowing into grip housing 150 as the grip housing 150 is separated from the drive housing by partitions 314. The grip housing 150 may be provided with its own dedicated ventilation and/or cooling means; alternatively, or in addition, a small amount of air may be permitted to flow from the drive housing 110 into the grip housing 150. The skilled person is aware of other means for providing air flow to the grip housing 150 and these will not be discussed further.

It is also desirable to minimise airflow through the area 312 defined by the space between the motor housing and walls of the drive housing 110. Although the motor itself generates significant heat, the surrounding areas tend to produce significantly less heat. Therefore, it is desirable to maximise air flow through the motor housing, e.g. through the motor’s annular gap and to minimise airflow around the motor housing.

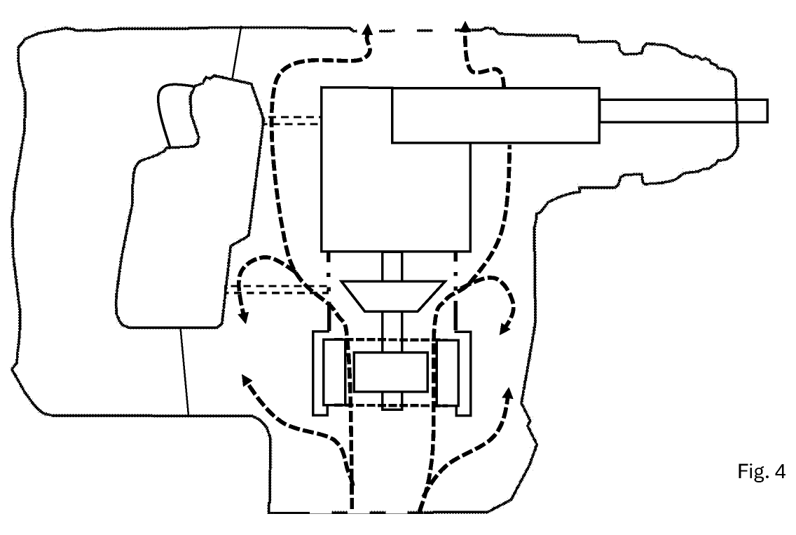

If significant air flow exiting the motor returns back towards the motor housing, the cooling system may be rendered less effective. An illustration of such flow is shown in FIG. 4. As can be seen, air flows into area 312 surrounding the motor housing 211. Additionally, after leaving the annular gap of the motor, air may also flow back upstream around the motor housing. This may also occur to air after having partially passed the gearbox. This upstream air flow is disadvantageous for several reasons. For instance, it can reduce the total flow rate of air through the tool, thus reducing the heat dissipation rate. Further, air that flows back upstream has already absorbed heat from the motor and/or gearbox which means that it is likely to be at a higher temperature than air entering the air inlet. This can lead to increased heat in, e.g. areas 312 and along the air flow path, and less efficient heat transfer from the motor and/or gearbox.

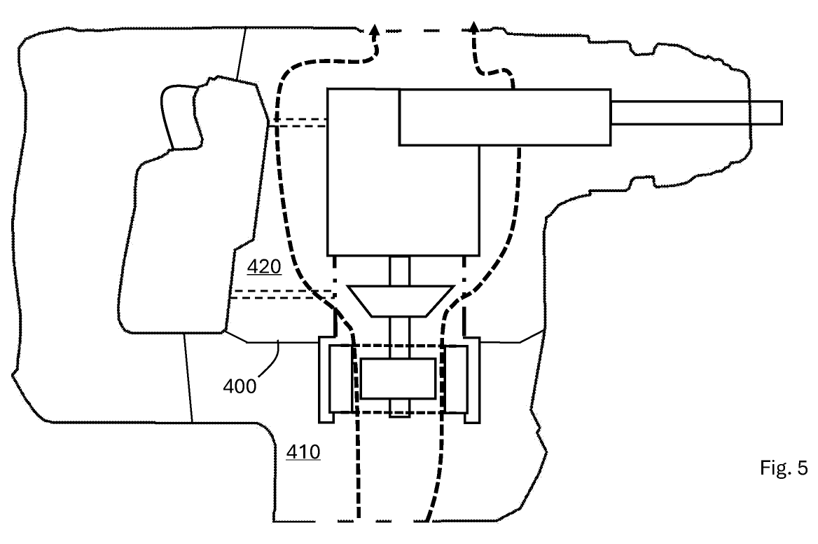

To prevent or at least significantly reduce the occurrence of these disadvantageous flow regimes, a divider 400 is used, as shown in FIG. 5. This provides a physical barrier which divides the drive housing 110 into a first internal section 410 upstream of the motor, which comprises the air inlet, and a second internal section 420 downstream of the motor, which comprises the air outlet. Air can only travel between the two volumes by flowing through an air flow passage, which moves with the assembly. Here, the air flow passage is defined by the annular gap of the motor; however, the air flow passage can be defined in additional, or alternative, ways as set out below. As shown, the divider extends from the floating assembly in the region of the motor and extends to the walls of the drive housing. As the motor usually produces the most heat and requires the most cooling, it is most advantageous to place the divider between the motor and the gearbox, so that warm air from the gearbox area does not recirculate around the motor housing and reduce cooling efficiency. Therefore, advantageously, the divider is attached to the floating assembly at a location at, or downstream of, the downstream end of the motor. However, the divider can be placed in other areas; moreover, multiple dividers could be used to reduce re-circulation of air in several areas.

The divider must be able to accommodate the reciprocating movement of the floating assembly within the drive housing. In particular, during operation the floating assembly will repeatedly move rearwards and forwards parallel to axis A. Thus, as the floating assembly moves rearward, it will get closer to the rearward walls of the drive housing and further from the forward walls of the drive housing; this will mean the rearward section of the divider is effectively shortened and the forward section of the divider is effectively lengthened. The same applies in reverse. The divider is less complex to implement at the sides (i.e. left and right) of the tool since the distance between the floating assembly and the left and right walls of the drive housing remains substantially constant as the floating assembly moves. The divider at the sides of the floating assembly can be formed, for instance, by linear bushings, or using any of the below described techniques.

One suitable form of divider is formed of an elastic and substantially air impermeable material (e.g. a rubber or silicone) which is able to elastically deform to accommodate movement of the assembly. This form of divider can extend around the entire perimeter of the floating assembly and can also do so using a continuous piece of material.

In other arrangements, the divider is comprised of at least two separate components which interact to minimise or eliminate air flow through the divider while accommodating movement of the assembly.

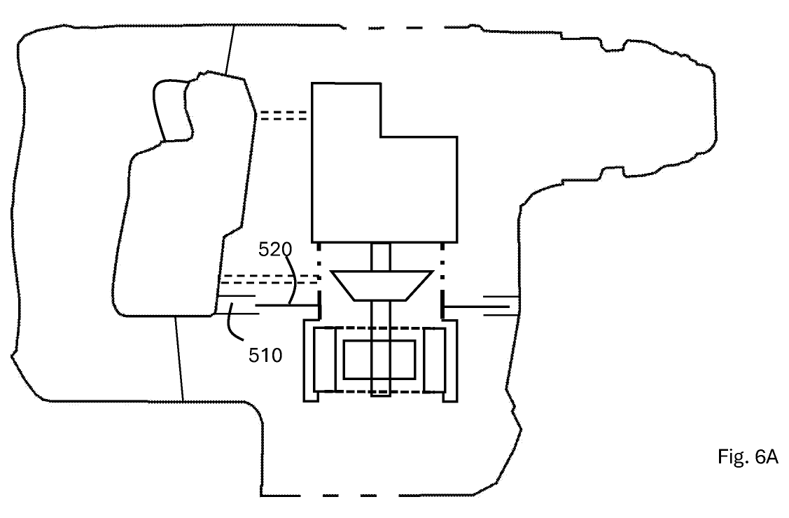

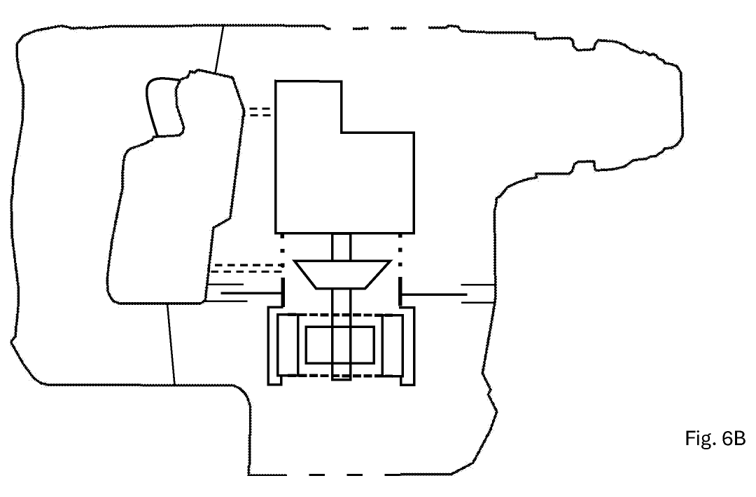

In one such arrangement, as shown in FIGS. 6A and 6B, a labyrinth structure is provided. The labyrinth structure comprises a set of grooved (or slotted) sections 510 and corresponding baffles 520. The grooved sections are attached to the walls of the drive housing and the corresponding baffles are attached to the floating assembly in the vicinity of the motor housing (or attached directly to the motor). In FIGS. 6A and 6B, hammer mechanism 240 and bit 260 are hidden and movement of chuck 130 is not shown. As the floating assembly reciprocates, the baffles also reciprocate within the grooves of the corresponding grooved sections. This forms a tortuous or convoluted path for the air to flow through, thus minimising the air that passes through the divider. In particular, the air must deviate 90 degrees to enter the labyrinth structure and flow along the baffle, a further 180 degrees to flow around the baffle and along the other side, and then a further 90 degrees to leave the labyrinth structure.

While it is not shown, the grooved sections are continuous and extend around the entire perimeter of the wall of the drive housing; similarly, the baffles are continuous and extend around the entire perimeter of the floating assembly. At the sides of the drive housing, the baffles reciprocate along the length of the corresponding grooved sections (i.e. parallel to axis A) and the gap between the baffle and corresponding grooved sections remains substantially constant.

The grooves of the grooved section lie on a first plane parallel to axis A and the corresponding baffles also lie on this first plane. In this manner, the baffles remain aligned with the grooves as the floating assembly reciprocates.

As shown, there is no contact between the baffles and grooves; this is advantageous in that wear of the components is reduced or eliminated, thus allowing a more reliable cooling system. In other arrangements, the baffles and corresponding grooves may be in contact to further reduce or eliminate the passage of air through the divider. Regardless of whether there is contact between the baffles and the corresponding grooves, grease or other lubricating or sealing substances may be used to reduce air transmission and/or reduce wear.

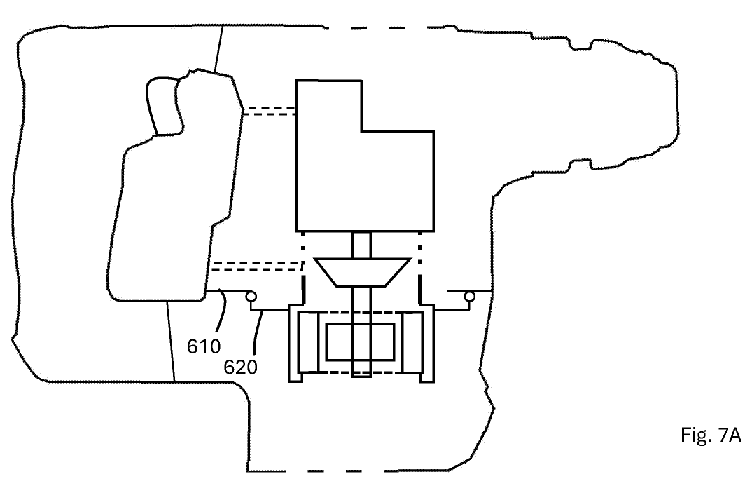

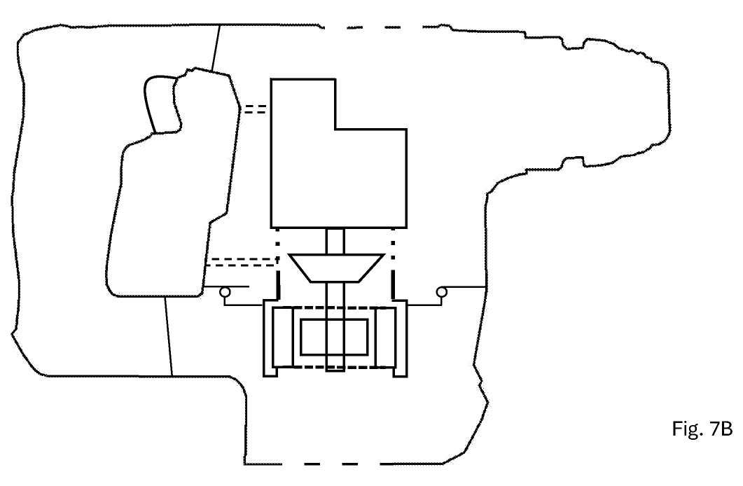

In another arrangement, shown in FIGS. 7A and 7B, wherein the divider comprises at least two separate components, the divider comprises a plate 610 fixedly attached to the walls of the drive housing and a sealing extension 620 attached to the floating assembly and/or motor housing. The plate extends around the entire perimeter of the walls of the drive housing. The plate extends substantially parallel to, but spaced apart from, an upper face of the motor housing so that a substantially constant gap between upper face of the motor housing and the plate exists as the floating assembly reciprocates. The centre of the plate, in the vicinity of the motor, comprises an aperture through which air is able to pass. The sealing extension extends from the motor housing and around the motor housing. The sealing extension thereby abuts the plate around the aperture and thus defines an air flow path through the annular gap of the motor and then through the aperture. As the floating assembly reciprocates, the sealing extension also reciprocates relative to the plate although maintains abutting contact. In FIGS. 7A and 7B, hammer mechanism 240 and bit 260 are hidden and movement of chuck 130 is not shown. In this manner, airflow through the divider is reduced or eliminated while airflow through the annular gap of the motor is allowed.

Having been informed of these sealing arrangements and forms of divider, the skilled person would be aware of other ways in which to provide such a divider.

The above-described tool demonstrates one approach to providing a power tool having improved cooling characteristics and also having improved vibration characteristics. The skilled person would understand that many modifications could be made to the above-described tool while retaining the advantages set out above. It is intended that these modifications fall within the scope of the disclosure. Other possible modifications are set out below, although the skilled person would understand that these do not form an exhaustive list.

As discussed above, partitions 160 act to divide the internal volume of the tool so as to form an effectively separate drive housing 110 and grip housing 150. In tool designs where a significant amount of air may flow through the grip housing, partitions 160 can prevent or significantly reduce this air flow. However, in other tool designs, only a small amount of air may flow through grip housing and partitions may not be required at all. The skilled person understands that the drive housing 110 and grip housing 150 can be treated separately in the context of this invention. In some scenarios, the grip housing 150 may be entirely separate to drive housing 110 and may be, e.g., secured to the drive housing 110 by fasteners.

As discussed above, the motor can be a brushless DC motor. Relative to a brushed DC motor, a brushless motor omits the brushes and commutator of the brushed DC motor. Omitting the brushes and commutator means that a brushless motor can be more efficient and more durable and made to generate less heat in use. However, a brushed DC motor can also be used. AC motors can also be used and this is advantageous in respect of corded tools. As shown, the motor comprises an external stator and an internal rotor; however, it is possible to have an external rotor and an internal stator.

As described, the fan is a radial fan intended to pull air axially from the annular gap of the motor and expel it radially. However, an axial fan can also be used in which air is both pulled and pushed axially. The fan may be formed of metal or it may be formed of plastic, or a mixture of both. In the above example, the fan is located on the motor shaft and therefore driven by the motor. However, the fan could comprise its own drive means, e.g., a second electric motor. In the above example, the fan is located on the motor shaft between the motor and the gearbox; however, the fan could be located anywhere along the air flow path from air inlet to air outlet. For instance, the fan may be attached to the drive housing at the air inlet or the air inlet. Moreover, the fan does not need to form part of the floating assembly and does not need to reciprocate within the drive housing.

In the above example, the air flow passage is defined by the annular gap of the motor. However, the motor may comprise multiple channels which collectively define the air flow passage. For instance, in addition to the annular gap, the air flow passage may comprise passages in the rotor and/or the stator. For instance, the rotor and/or stator may each comprise a series of passages spaced circumferentially apart about longitudinal axis B of the motor. The air flow passage may therefore comprise at least the annular gap of the motor and at least one passage through each of the rotor and/or stator.

As described, the air inlet and air outlet are formed by slots in the drive housing. These slots may be covered by a mesh to minimise the risk of foreign objects entering the drive housing. The mesh may be a separate component or it may be formed as part of the drive housing. Alternatively, the air inlet and air outlet may not comprise slots, but may comprise at least one opening into the drive housing. While it is preferred to use a separate air inlet and air outlet, in some tool designs it may be possible to use a single opening for both the air inlet and air outlet. As described, the fan is directly attached to the motor shaft. Alternatively, the fan may be driven by the motor shaft via a gearbox, which may allow for different fan speeds. Alternatively, or in addition, the fan may be electrically driven.

As described, the gearbox housing is formed of metal. However, the gearbox housing may be formed of plastic or a combination of metal and plastic. If plastic is used, a thermally conductive plastic may be used, for instance, a plastic containing thermally conductive additives. The gearbox may comprise ribs or may be textured to increase heat dissipation.

As discussed, the motor housing is fixedly connected to the gearbox housing to form a floating assembly. However, the skilled person is aware of other arrangements that could be used to form a floating assembly; for instance, the floating assembly may comprise a frame to which the motor and gearbox are fixedly connected. As described above, the chuck forms part of, and moves with, the floating assembly; however, the skilled person is aware that in other embodiments the floating assembly may not comprise the chuck and may therefore translate or reciprocate independently of the chuck.

As shown, the divider divides or separates the housing into two sections by extending from the walls of the drive housing and extending to the floating assembly in the vicinity of the motor. Thus, the divider directly attaches to the floating assembly. The divider may directly attach to the motor housing or the gearbox housing. Where the divider comprises separate parts, contact between said parts may be minimised, or eliminated, to reduce wear. However, contact between separate parts of the divider may be permitted to occur at the end ranges of the travel of the floating assembly. Alternatively, contact between the separate parts of the divider may be permitted at all times and friction reducing means may be used to minimise wear. As discussed above, grease or other lubricating or sealing substances may be used to reduce air transmission through the divider and/or to reduce wear. Where the divider comprises separate parts, at least one of the separate parts may comprise a non-stick coating, e.g. PTFE, or a wear resistant coating to reduce wear.

As described, the divider may comprise grooved sections and corresponding baffles that reciprocate within the grooves of the grooved sections. The grooved sections may be continuous and extend around the entire perimeter of the wall of the drive housing, and the baffles may also be continuous and extend around the entire perimeter of the floating assembly. Alternatively, the grooved sections and baffles may be discrete and may exist as corresponding sets on only some of the walls of the drive housing. As described above, one set of grooved sections and corresponding baffles were provided on a first plane. However, additional sets may be provided on planes spaced apart from but parallel with the first plane; in this way, air can be forced to deviate an additional number of times to pass through the combined sets of grooved sections and baffles. The additional sets of grooved sections and baffles can take the same form as the sets described above.

Examples of the invention include a power tool that includes a drive housing having an air inlet and an air outlet; an assembly movably mounted within the drive housing, wherein the assembly has a motor and an air flow passage; a fan configured to generate airflow from the air inlet to the air outlet; a divider configured to divide the drive housing into a first internal section including the air inlet and a second internal section including the air outlet, the first internal section and the second internal section fluidly linked by the air flow passage, wherein the divider substantially reduces or prevents airflow between the first and second internal sections except through the air flow passage. The divider includes a labyrinth structure, at least part of which is coupled to the assembly.

A further example of the invention incudes a power tool comprising: a drive housing including an air inlet and an air outlet; an assembly movably mounted within the drive housing, wherein the assembly comprises a motor and an air flow passage; a fan configured to generate airflow from the air inlet to the air outlet; a divider configured to divide the drive housing into a first internal section upstream of the motor and a second internal section downstream of the motor, wherein the first internal section includes the air inlet and the second internal section includes the air outlet, the first internal section and second internal section fluidly linked by the air flow passage. The divider substantially reduces or prevents airflow between the first and second internal sections except through the air flow passage. At least part of the divider moves with the assembly.

The power tool of the aforementioned examples includes a chuck configured to hold a bit, wherein the bit defines a first axis along its length and wherein the bit is configured to rotate about and/or translate along the first axis.

The power tool of the aforementioned examples, wherein the assembly is movably mounted within the drive housing such that it can reciprocate parallel to the first axis.

The power tool of the aforementioned examples wherein the assembly comprises the fan.

The power tool of the aforementioned examples, wherein the assembly comprises a gearbox located in the second internal section, and wherein the motor comprises a motor shaft configured to drive the gearbox.

The power tool of the aforementioned examples, wherein the motor comprises a motor shaft to which the fan is mounted such that the motor is configured to drive the fan.

The power tool of the aforementioned examples, wherein the motor, fan, and gearbox are axially separated along a second axis, the second axis defined by the motor shaft axis, wherein the motor and gearbox are separated by the fan.

The power tool of the aforementioned examples, wherein the gearbox comprises a gearbox housing, wherein air is configured to flow around the gearbox housing so as to cool the gearbox.

The power tool of the aforementioned examples, wherein the air flow passage extends from an upstream face of the motor to a downstream face of the motor.

The power tool of the aforementioned examples, wherein the motor comprises a stator and a rotor, wherein an annular gap exists between the rotor and the stator, wherein the air flow passage is at least partially defined by the annular gap.

The power tool of the aforementioned examples, wherein the air inlet and/or air outlet are formed by openings in the walls of the drive housing.

The power tool can be a radial fan or an axial fan.

The power tool of the aforementioned examples, wherein the divider comprises an apertured plate and a sealing extension attached to the assembly and configured to sealing engage around the aperture, wherein the aperture and sealing extension are sized such that the sealing extension remains sealing engaged around the aperture as the assembly moves. The motor comprises a motor shaft, wherein the motor shaft passes through the aperture. The sealing extension has an annular shape.

The power tool of the aforementioned examples, wherein the divider comprises a labyrinth structure that comprises at least one first grooved section extending from a wall of the drive housing and at least one first baffle attached to the assembly, wherein the at least one first baffle is configured to move within a groove of the at least one first grooved section as the assembly moves relative to the drive housing.

The power tool of the aforementioned examples, wherein the at least one first grooved section comprises a front grooved section attached to a front wall of the drive housing and a rear grooved section attached to a rear wall of the drive housing, the front and rear wall being separated along the first axis, wherein the at least one first baffle comprises corresponding front and rear baffles attached to the assembly.

The power tool of the aforementioned examples, wherein the at least one first grooved section comprises a front grooved section attached to the front wall of the drive housing and a rear grooved section attached to the rear wall of the drive housing and side grooved sections attached to the respective side walls adjoining the front and rear walls, wherein at least one first baffle comprises corresponding front, rear and side baffles attached to the assembly.

The power tool of the aforementioned examples, wherein the at least one first grooved section extends substantially continuously around a perimeter of the front, rear, and side walls of the drive housing and wherein the at least one first baffle extends substantially continuously around the assembly in a corresponding manner. The at least one first baffle does not contact the at least one first grooved section as the assembly moves relative to the drive housing. The at least first baffle is separated from the at least one first grooved section by grease or other lubricating material. The grooves of the at least one first grooved section lie in a first plane and wherein the baffles of the at least one first baffle lie in the first plane.

The power tool of the aforementioned examples, wherein the labyrinth structure comprises at least one second grooved section comprising one or more grooves in a second plane different to the first plane, and wherein the labyrinth structure further comprises at least one second baffle attached to the assembly, wherein the at least one second baffle lies in the second plane.

The power tool of the aforementioned examples, wherein the divider comprises an elastic material connected to the assembly and to the walls of the drive housing.

The power tool of the aforementioned examples, wherein power tool is a hammer drill, a rotary hammer, a demolition drill, or a reciprocating saw.

The power tool can include a hammer mechanism configured to impact bits held in the chuck. The hammer mechanism includes a floating part and a fixed part. The assembly comprises the floating part of the hammer mechanism and the fixed part of the hammer mechanism is fixed in position relative to the drive housing.

The power tool of the aforementioned examples, wherein the drive housing comprises at least one steel pin on which the assembly is configured to slidably translate, wherein the at least one steel pin is fixedly connected to the drive housing.

The power tool of the aforementioned examples, wherein the power tool comprises at least one compression spring configured to damp the motion of the assembly. The at least one compression spring is parallel to the first axis.

The power tool of the aforementioned examples, wherein the power tool comprises a battery removably located in a battery compartment, wherein the battery powers the motor. The battery is at least partially decoupled from the drive housing by a dampening element.

The power tool of the aforementioned examples additionally comprises a grip housing attached to the tool housing, wherein the grip housing comprises a trigger for operating the power tool. The motor comprises a motor housing, wherein the divider is attached to the motor housing.

The power tool of the aforementioned examples, wherein the overall direction of airflow from air inlet to air outlet is substantially perpendicular to the first axis.

The appended claims define the invention. However, the skilled person would become aware of other possible modifications to the disclosed power tool upon reading this present disclosure; it is intended that the present disclosure covers these modifications.

What is claimed is:

1. A power tool comprising:
a drive housing comprising an air inlet and an air outlet;
an assembly movably mounted within the drive housing, wherein the assembly comprises a motor and an air flow passage;
a fan configured to generate airflow from the air inlet to the air outlet; and
a divider configured to divide the drive housing into a first internal section comprising the air inlet and a second internal section comprising the air outlet, the first internal section and the second internal section fluidly linked by the air flow passage, wherein the divider substantially reduces or prevents airflow between the first and second internal sections except through the air flow passage,
wherein the divider comprises a labyrinth structure, at least part of which is coupled to the assembly.

2. A power tool comprising:
a drive housing comprising an air inlet and an air outlet;
an assembly movably mounted within the drive housing, wherein the assembly comprises a motor and an air flow passage;
a fan configured to generate airflow from the air inlet to the air outlet; and
a divider configured to divide the drive housing into a first internal section upstream of the motor and a second internal section downstream of the motor, wherein the first internal section comprises the air inlet and the second internal section comprises the air outlet, the first internal section and second internal section fluidly linked by the air flow passage, wherein the divider substantially reduces or prevents airflow between the first and second internal sections except through the air flow passage, and wherein at least part of the divider moves with the assembly.

3. The power tool of claim 2, wherein the power tool comprises a chuck configured to hold a bit, wherein the bit defines a first axis along its length and wherein the bit is configured to rotate about and/or translate along the first axis.

4. The power tool of claim 3, wherein the assembly is movably mounted within the drive housing such that it can reciprocate parallel to the first axis.

5. The power tool of claim 2, wherein the assembly comprises the fan.

6. The power tool of claim 2, wherein the assembly comprises a gearbox located in the second internal section, and wherein the motor comprises a motor shaft configured to drive the gearbox.

7. The power tool of claim 2, wherein the motor comprises a stator and a rotor, wherein an annular gap exists between the rotor and the stator, wherein the air flow passage is at least partially defined by the annular gap.

8. The power tool of claim 2, wherein the divider comprises a labyrinth structure.

9. The power tool of claim 8, wherein the labyrinth structure comprises at least one first grooved section extending from a wall of the drive housing and at least one first baffle attached to the assembly, wherein the at least one first baffle is configured to move within a groove of the at least one first grooved section as the assembly moves relative to the drive housing.

10. The power tool of claim 8, wherein the at least one first grooved section comprises a front grooved section attached to a front wall of the drive housing and a rear grooved section attached to a rear wall of the drive housing, the front and rear wall being separated along the first axis, wherein the at least one first baffle comprises corresponding front and rear baffles attached to the assembly.

11. The power tool of claim 10, wherein the at least one first grooved section comprises a front grooved section attached to the front wall of the drive housing and a rear grooved section attached to the rear wall of the drive housing and side grooved sections attached to the respective side walls adjoining the front and rear walls, wherein at least one first baffle comprises corresponding front, rear and side baffles attached to the assembly.

12. The power tool of claim 2, wherein the divider comprises an apertured plate and a sealing extension attached to the assembly and configured to sealing engage around the aperture, wherein the aperture and sealing extension are sized such that the sealing extension remains sealing engaged around the aperture as the assembly moves.

13. The power tool of claims claim 10, wherein the divider comprises an elastic material connected to the assembly and to the walls of the drive housing.

14. The power tool of claim 2, wherein the motor comprises a motor housing, wherein the divider is attached to the motor housing.

15. The power tool of claim 2, wherein power tool is a hammer drill, a rotary hammer, a demolition drill, or a reciprocating saw.
